(19) United States
(12) Patent Application Publication
(10) Pub. No.: US 2005/0151998 A1
(43) Pub. Date: Jul. 14, 2005

(54) Method and system for creating and using modifiable print files

(76) Inventors: David Pettigrew, Corvallis, OR (US); Paul J. McClellan, Bend, OR (US); Kenneth R. Creel, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/754,376

(22) Filed: Jan. 9, 2004

(51) Int. Cl. G06K 15/02

(52) U.S. Cl. 358/1.18

(57) ABSTRACT

A method of printing printed content includes creating one or more print files defining the printed content such that the print files adhere to a pre-defined format. The method also includes using the print files to render the printed content to a print device. The pre-defined format is configured to allow the print files to be modified after the print files have been initially created.

### BACKGROUND

Optical discs have fast become an industry standard for data storage in the fields of computers, video, and music. Optical discs include, but are not limited to, compact discs (CDs), digital video (or versatile) discs (DVDs), and game system discs in a variety of formats. Commercially produced optical discs typically have digital data recorded on one side of the disc and a visual display, or a label printed on the other side of the disc.

Some optical discs have been created that can store data on both sides of the disc. However, in many cases it is desirable to limit the optical disc data to a single side of the disc, leaving the other side of the disc for printed text, patterns, or graphics. The printed labeling on a non-data side of an optical disc can include images such as a decorative design, text identifying the data stored on the disc, or both.

As optical technology has advanced, writeable and re-writable optical discs as well as equipment for writing onto the discs have become reasonably priced within the grasp of ordinary consumers. Thus, many consumers currently have the ability to burn data onto optical discs with home or office computers that have optical disc drives. For example, consumers may, in some instances, purchase CD or DVD data from a website on the Internet and burn the data onto their own CD or DVD.

Many consumers also desire to print labels, lyric sheets, user manuals, case inserts, case covers, and/or other printed content associated with optical discs. There are a number of print devices currently available to consumers. For example, some disc drives are capable of printing a label directly onto an optical disc by applying a laser to the disk in certain patterns thereby altering the disc's optical properties. Additional print devices that may be used to print the printed content include “direct on disc” printers and traditional inkjet and laser printers.

There are currently a number of applications that may be used to create a label or other type of printed content. Each application typically has its own unique format defining a template that describes the base layout of the printed content. A user may add text and/or images to this template to create the desired printed content. Once the desired text and/or images have been added to the template, the application may then send the printed content to a processor or a print device as a print file. The print device prints the printed content based on the print file. A print file is often a binary object such as a bitmap file. However, binary objects are not human-readable. Thus, once the printed content has been stored as a binary object, it is difficult to modify the layout of the printed content at a later time. Furthermore, it is difficult or impossible for a print device to modify the text and images that may be included in the printed content if the printed content is contained in a binary object such as a bitmap file.

### SUMMARY

A method of printing printed content includes creating one or more print files defining the printed content such that the print files adhere to a pre-defined format. The method also includes using the print files to render the printed content to a print device. The pre-defined format is configured to allow the print files to be modified after the print files have been initially created.

### BRIEF DESCRIPTION OF THE DRAWINGS

The accompanying drawings illustrate various embodiments of the present system and method and are a part of the specification. The illustrated embodiments are merely examples of the present system and method and do not limit the scope thereof.

FIG. 1 shows an example of an optical disc that has a label on one if its surfaces according to one exemplary embodiment.

FIG. 2 illustrates an exemplary method of forming printed content using a content file and a layout file according to one exemplary embodiment.

FIG. 3 illustrates an exemplary method of forming printed content using a single print file that includes content and layout information according to one exemplary embodiment.

FIG. 4 is a representation of an exemplary content file with a number of elements or fields according to one exemplary embodiment.

FIG. 5 is a simplified block diagram illustrating an exemplary system for creating one or more print files and then printing printed content corresponding to an optical disc according to one exemplary embodiment.

Throughout the drawings, identical reference numbers designate similar, but not necessarily identical, elements.

### DETAILED DESCRIPTION

The present specification describes a method wherein an application is configured to print a label or any other printed content by using print files that may be modified after creation. The print files are configured to use a pre-defined format which allows any application configured to read simple text files to modify the print files after they have been created. The print files may include a content file and a layout file. The content file defines the text and image elements associated with the printed content, while the layout file defines the layout of the text and image elements that are defined by the content file.

As used in this specification and the appended claims, the term “optical disc” is used broadly to encompass discs for recording music, pictures, video, video games, and/or software, etc. An optical disc includes, but is not limited to, writable and rewritable storage devices including, Compact Discs (CDs), Compact Disc Read-Only Memory (CD-ROMs), Minidiscs, Digital Video (or Versatile) Discs (DVDs) in various formats, and video game discs in various formats.

“Printed content” means, unless otherwise specifically denoted, any label, case insert, case cover, lyric sheet, user manual, or any other content that is printed. The printed content may be associated with an optical disc. The printed content may also be associated with any object other than an optical disc. For example, the printed content may be a label that is to be affixed to a box, a computer, or any other device. However, for illustrative purposes only, the following descriptions will illustrate printed content that is associated with an optical disc.

As used in this specification and in the appended claims, unless otherwise specifically denoted, “print file” refers to a file that is used by a processor or a print device to form printed content associated with an optical disc or some other object. A print file may be created by an application, a user, or some other device. “Application” means, unless otherwise specifically denoted, any software, program, device, or system configured to create one or more print files that are used to print printed content. An exemplary, but not exclusive, application is a program that allows a user to design and print a custom label for an optical disc.

A common example of printed content is a label. The term “label” means any text, printed pattern, graphical design or combination thereof affixed to an object such as an optical disc. If a label is added to an optical disc, the label is typically found on one side of the optical disc, although this is not necessarily the case. It is also possible to have a label on both sides of an optical disc.

As already noted, printed content may include text and image elements. “Text element” means, unless otherwise specifically denoted, any text, letters, words, symbols, or characters that are included in the printed content. “Image element” means any graphic or image that is included in the printed content.

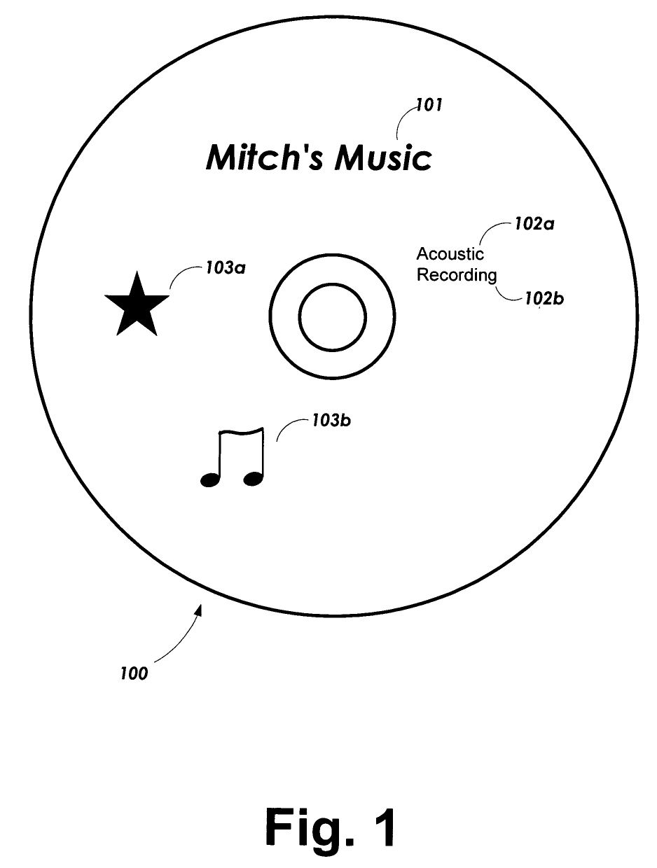

FIG. 1 shows an example of an optical disc (100) that has a label on one of its sides according to one exemplary embodiment. As shown in FIG. 1, the optical disc (100) may have a label including a title (101), a number of additional text elements (102a,b), and/or a number of image elements (103a,b). The title (101), text elements (102a,b), and/or image elements (103a,b) may be located in any position on the optical disc (100), according to one exemplary embodiment. The title (101) in FIG. 1 is a text element. Although two additional text elements (102a,b) and two image elements (103a,b) are shown in the exemplary layout of FIG. 1, it will be recognized that any number of text and image elements may be included on the label.

The printed content may be formed on the optical disk (100) illustrated in FIG. 1 by any number of different print devices. According to one exemplary embodiment, the printed content may be formed by an optical disc drive that applies a laser to the optical disc (100) in selected patterns to print a label directly on the optical disc. According to one exemplary embodiment, the laser used to label the optical disk (100) may be the same laser used to burn data onto the optical disc. The application of the laser to the surface of the optical disk (100) changes the optical properties (such as reflectivity) of the exposed portions, resulting in patterns that can be made large enough to be visible to users. A number of commercially available systems may be used to label an optical disc (100) using a laser. For example, optical disc drives such as CD Readwrite (RW), CD record (CD-R), DVD-R, or DVD-RW drives may be used to print a label or other printed content onto an optical disc (100). Additionally, other products capable of writing to optical discs may be used to print labels and other printed content including, but not limited to, large scale optical disc recorders that are used for mass production of labeled and recorded optical discs.

According to another exemplary embodiment, a “direct on disc” printer may be used to print a label onto an optical disc (100). A “direct on disc” printer may be an inkjet or other type of printer that is configured to print with ink directly onto the surface of an optical disc. In an alternative embodiment, a printer is used to print the desired label onto paper having an adhesive element so that the label may be attached to the optical disc.

The label of FIG. 1 is only an example of one of many types of printed content. It will be understood that additional printed content associated with an optical disc or other object, as described above, may be printed by a print device as prescribed by the content and layout files described below.

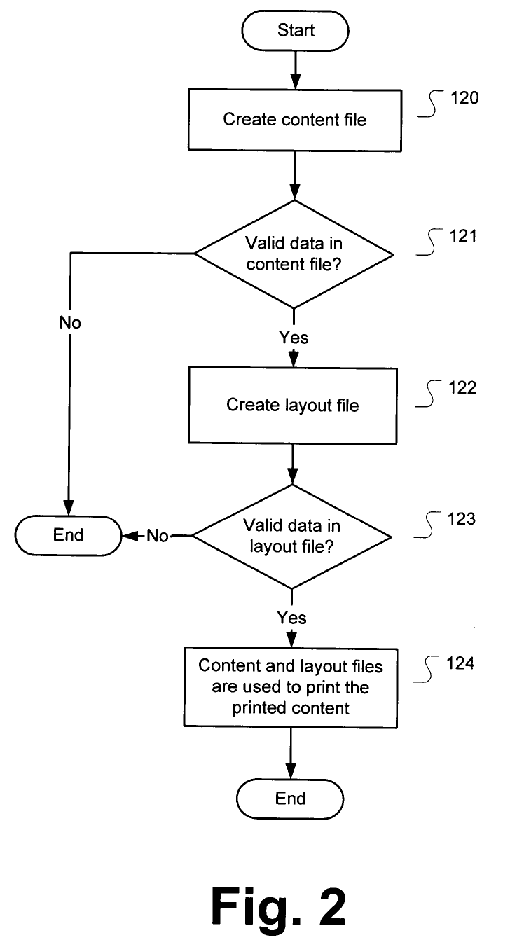

FIG. 2 illustrates an exemplary method of forming printed content using a content file and a layout file according to one exemplary embodiment. It will be recognized that the method described in connection with FIG. 2 is exemplary only and may employ more or less steps than those steps shown. Furthermore, the order in which the steps are performed may be modified.

As shown in FIG. 2, a content file is first created (step 120). The content file defines the text and/or image elements associated with the printed content. For example, the content file may include the title of the printed content, additional text that is to be included in the printed content, and/or information regarding images that may be included in the printed content. While the exemplary method of FIG. 2 is illustrated using only one content file, any number of content files may be used to define the text and image elements associated with the printed content. An exemplary situation in which multiple content files may be used is when printed content is to be printed in multiple sessions. For example, additional text or image elements may be added to an already-printed label associated with an optical disc.

In one exemplary embodiment, an application creates the content file (step 120). For example, the application may create the content file by prompting a user to manually input information that is to be included in the content file. In an alternative embodiment, the application may automatically create the content file based on information obtained from the Internet, a network, a corresponding optical disc or object, or any other source of printed content information.

Moreover, the content file may be created by an application in any of a number of programming languages or syntaxes. An exemplary language in which the content file may be created is Extensible Markup Language (XML). XML is a World Wide Web Consortium standard that lets users create their own tags. XML allows the content file to be easily adapted to different applications. However, XML is exemplary in nature only, and not limiting. For example, the content file may be created in other languages including, but in no way limited to, Cascading Style Sheets (CCS), Hyper Text Markup Language (HTML), Java, and others.

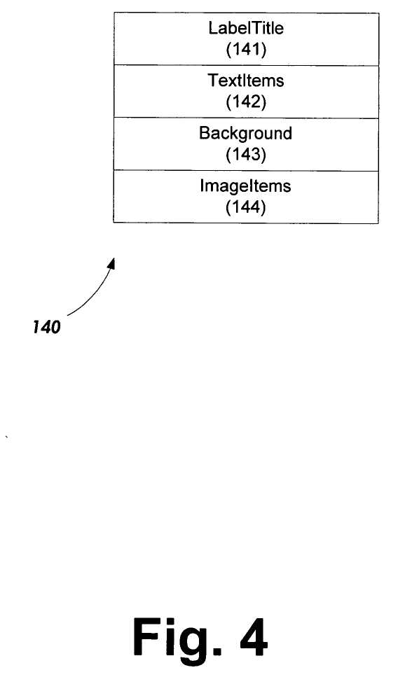

In another exemplary embodiment, a user may manually create the content file (step 120) without the aid of an application specifically designed to create print files. For example, a user may manually create a content file in any of a number of programming languages or syntaxes such as XML, CCS, HTML, or Java. An exemplary content file will be explained in more detail below with reference to FIG. 4.

After the content file is created, an application may optionally check or parse for valid data in the content file (step 121). Valid data is data that complies with the pre-defined format. In one embodiment, the data in the content file may be validated against a schema. A schema is a set of pre-defined rules governing the structure and type of information that may be included in the content file. For example, an exemplary schema may require that only one title be included in the content file. If more than one title is included in a particular content file, a comparison of the content file with the exemplary schema would indicate that the data is not valid (No, step 121). In one embodiment, an invalid content file may not be used to print printed content.

According to one exemplary embodiment, the application in which the content file is created also checks for valid data in the content file. In an alternative embodiment, an application, program, or device separate from the application in which the content file is created validates the data in the content file. It will be understood that the step of checking for valid data in the content file (step 121) is optional. Accordingly, in an alternative embodiment, the content file is not checked for valid data.

If the data in the content file is valid (Yes, step 121), a layout file is next created (step 122). As will be recognized by one skilled in the art, the order in which the content and layout files are created may be interchanged. The layout file defines the layout attributes of the text and image elements that are defined by the content file. “Layout attributes” refer to the specific fonts, sizes, positioning, layer attributes, and other visual effects of the text and image elements that are to be used in the printed content. In one exemplary embodiment, an application creates the layout file. For example, the application may create the layout file by prompting a user to manually input information defining the layout attributes of the different text and image elements associated with the printed content. In an alternative embodiment, the application may automatically create the layout file based on information obtained from the Internet, a network, a corresponding optical disc or object, or any other source of printed content information. Additionally, the application may create the layout file (step 122) in any number of programming languages or syntaxes such as XML or CCS.

Similar to the creation of the content file, a user may create the layout file manually without the aid of an application specifically designed to create print files. For example, a user may create a layout file in any of a number of programming languages or syntaxes such as XML or CCS. An exemplary layout file will be explained in detail below.

The exemplary method of FIG. 2 is illustrated using one layout file. However, in an alternative embodiment, any number of layout files may be used to define the layout attributes of the text and image elements associated with the printed content. An exemplary situation in which multiple layout files may be used is when the same text and image elements are to be printed on multiple optical disks having different layout attributes. For example, it may be desirable for two optical discs to have the same label contents with different layout attributes.

After the layout file is created (step 122), an application may check for valid data in the layout file (step 123). The data in the layout file may be validated against a schema in a similar manner as was described in connection with the content file. The schema used to validate the layout file may be a set of rules defining the possible positions, fonts, font sizes, and other visual effects that the layout file is allowed to have. For example, if the data in the layout file indicates that a particular text element is to be in a font that is not allowed by the schema, the data in the layout file would be deemed not valid (No, step 123). In one embodiment, an invalid layout file may not be used to print printed content. It will be understood that the step of checking for valid data in the layout file (step 123) is optional. According to one embodiment, the layout file is not checked for valid data.

After the content and layout files have been created (step 120, 122) and optionally validated (step 121, 123), the content and layout files are used to print the printed content (step 124). A processor or print device that uses the content and layout files to print printed content may be configured to automatically recognize which of the print files is the content file or files and which of the print files is the layout file or files. In one embodiment, the content file or files may be given names that the application or print device recognizes as being names of content files. Likewise, the layout file or files may be given names that the processor or print device recognizes as being names of layout files.

Furthermore, a processor or print device may be configured to automatically modify the layout attributes of the content file and/or the layout file to adapt for different print geometries. For example, the content file and/or the layout file may be automatically modified to account for different optical disc sizes and/or shapes.

The method described in connection with FIG. 2 uses separate print files to define the content and the layout attributes of the text and image elements of printed content that is associated with an optical disc. The use of separate print files such as the content file and the layout file described in connection with FIG. 2 allows the layout attributes of the text and image elements of the content file to be easily modified without having to modify the text and image elements themselves. Furthermore, the use of separate print files to form printed content allows a user to create printed content containing varied text and image elements with consistent appearance and layout. For example, a user may desire to print labels for a number of different optical discs, each label having a different title, text, and/or images. However, the same layout attributes may be used for each label simply by defining a single layout file that may be used in combination with various content files to create the different labels.

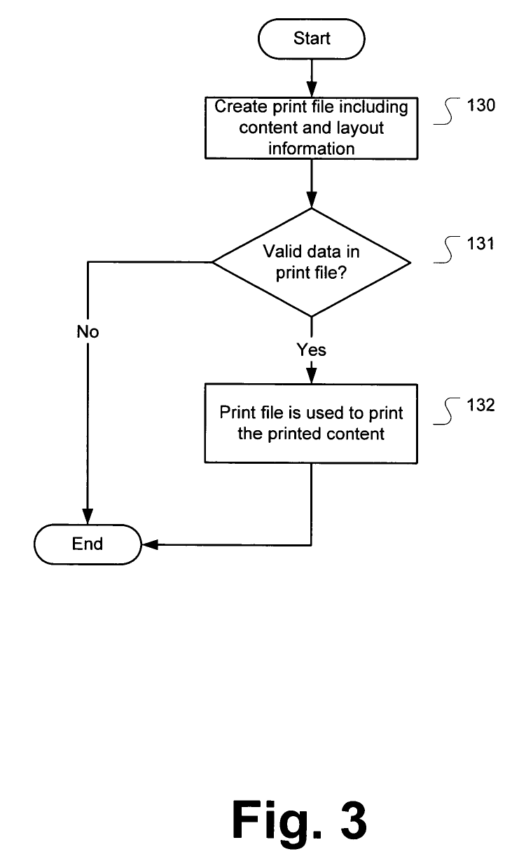

In an alternative embodiment, a single print file may be created and used to print printed content. The single print file includes the information contained in the content and layout files described in connection with FIG. 2. FIG. 3 illustrates an exemplary method of printing printed content using a single print file that includes both the content and layout information. As shown in FIG. 3, the method begins by creating a print file including both content and layout information (step 130).

In one embodiment, an application creates the single print file having both content and layout information. For example, the application may create the print file by prompting a user to manually input the information that is to be included in the print file. This information may include individual text and image elements as well as their respective layout attributes. In an alternative embodiment, the application may automatically create the content file based on information obtained from the Internet, a network, a corresponding optical disc, or any other source of printed content information. A user may alternatively create the print file manually without the aid of an application specifically designed to create print files. For example, a user may create a layout file in any of a number of programming languages or syntaxes such as XML or CCS.

After the print file is created (step 130), an application may check for valid data in the print file (step 131). The data in the print file may be validated against a schema in a similar manner as was described in connection with the content and layout files of FIG. 2. In one embodiment, an invalid print file (No, step 131) may not be used to form printed content. It will be understood that the step of checking for valid data in the print file (step 131) is optional. In one embodiment, the print file is not checked for valid data. After the print file has been created and optionally validated, the print file may be used to print the printed content (step 132) using any one of the above-mentioned methods.

An exemplary content file and an exemplary layout file will now be given for illustrative purposes. The following exemplary content and layout files may be used to print the label shown in FIG. 1 by using the exemplary method described in connection with FIG. 2. It will be recognized that the files are exemplary only, and are in no way exhaustive or limiting. The elements of both the content file and the layout file may be modified, renamed, added to, or taken away from as best serves a particular application.

FIG. 4 is a representation of an exemplary content file (140) with a number of elements or fields (141-144). The elements (141-144) are various descriptor terms that, when combined with specific information, allow an application to distinguish between different text and image elements of the printed content. The exemplary content file elements of FIG. 4 correspond to a label that is to be printed for illustrative purposes only. It will be understood that the elements may be modified, added to, or removed to print different types of printed content.

As shown in FIG. 4, one of the exemplary elements is labeled “LabelTitle” (141). This element holds information about the title of the printed content. A user may input desired text into the “LabelTitle” field. The input text will then be recognized and formatted as the title of the printed content.

Another exemplary element of the content file is “TextItems” (142). The “Textltems” element holds information about the various text elements that are to be included in the label. According to one embodiment, a user may input desired text elements into the “TextItems” field.

Another exemplary element of the content file is “Background” (143). The “Background” element holds information about the desired background of the label. For example, a user may input a file name of a particular image that is to be used as the background into the “Background” field.

Another exemplary element of the content file is “ImageItems” (144). The “ImageItems” element holds information about the various image elements that are to be included in the label. In one embodiment, a user may input desired image elements into the “ImageItems” field.

Below are some exemplary elements of a content file corresponding to the label of FIG. 1. The following sample code is given for illustrative purposes only, and may be modified in syntax and/or content, as will be understood by one skilled in the art. The exemplary sample code below is in XML. An explanation of the code will be given after the code is presented.

```
<LabelContent>
  <LabelTitle>Mitch's Music </LabelTitle>
  <TextItems>
    <Item r = 30 theta = 48>
      <text>Acoustic </text>
    </Item>
    <Item r = 25 theta = 45>
      <text>Recording </text>
    </Item>
  </TextItems>
  <background>
    <image>Simple.jpg</image>
  </background>
  <ImageItems >
    <image r = 35 theta = 175>Star.jpg</image >
    <image r = 35 theta = 245>Notes.jpg</image >
  <ImageItems>
</LabelContent>
```

This portion of an exemplary content file shows that the label's title is to be “Mitch's Music.” The content file also shows that two text elements are to be included in the label. As shown in the exemplary code, a user may input a general position where a particular text or image element is to be displayed. For example, the first text element, “Acoustic,” is to be displayed at a normalized distance of r=30 from the center of the optical disc at an angle of 48 degrees. The layout file may define the exact dimensions of the optical disc, therefore allowing the text and image elements to be displayed in correctly positioned locations. The code also shows that a second text element, “Recording,” is to be displayed at a normalized distance of r=25 from the center of the optical disc at an angle of 45 degrees.

The exemplary content file also shows that the label's background is to be “Simple.jpg.” According to one exemplary embodiment, the background may be any image accessible by the host device. The exemplary content file also shows that the label is to have two images included in the label. The first image, “star.jpg,” is to be displayed at a normalized distance of r=35 from the center of the optical disc at an angle of 175 degrees. Similarly, the second image, “notes.jpg” is to be displayed at a normalized distance of r=35 from the center of the optical disc at an angle of 245 degrees.

The exemplary content file defines the positioning of text and image elements using a polar coordinate system for illustrative purposes only. The polar coordinate system is only one of many different positioning coordinate systems that may be used in the content file and in the layout file according to an exemplary embodiment. For example, in one embodiment, a radial-tangential coordinate system with coordinates (r, t) may be used. In a radial-tangential coordinate system, “r” is the radius from the center of an optical disc and “t” is the distance from a reference radial line in a reference direction along the circle defined by the radius, r. The reference radial direction may, for example, be a counter-clockwise direction along the circle defined by r. Other coordinate systems may also be used to define the positioning of the text and image elements as best serves a particular application. Furthermore, the exact positioning of the text and image elements in relation to the center of the disc may be defined differently to best serve a particular application. For example, the normalized distance of 30 may refer to the left edge or to the center of the text element “Acoustic.”

A content file may also include a reference to a corresponding layout file or files. The portion of code given above for the exemplary content file does not show a reference to a corresponding layout file.

As mentioned above, a content file may be modified by a user or by an application after the content file has been created. For example, a user who wishes to modify the contents of the printed content defined by the exemplary content file shown above may replace the text and image elements in the exemplary content file shown with different text and image elements.

Exemplary elements of a layout file corresponding to the label of FIG. 1 will now be given. The following sample code is given for illustrative purposes only, and may be modified in syntax and/or content, as will be understood by one skilled in the art. The exemplary sample code below is in Cascading Style Sheets (CCS). CCS is an exemplary, but not exclusive, language that may be used to implement the layout file. An explanation of the code will be given after the code is presented.

LabelTitle {text-align: center; innermargin-radial: 24 mm; font-family: serif; font-size: 20 pt; color: blue}

textitems{text-align: left; font-family: sans-serif; background: white; color: black; font-size12 pt}

imageitems{size-x:10 mm; size-y:12 mm}

This portion of an exemplary layout file defines the particular layout attributes of the title, additional text elements, and image elements of the exemplary content file given above. The exemplary code defines a number of layout attributes for the title, text, and images such as text alignment, font type, font size, font color, and image size. However, it will be recognized that these layout attributes are exemplary only and may be modified, added to, or removed as best serves a particular application.

As previously mentioned, a layout file may also be modified by a user or by an application after the content file has been made. For example, a user who wishes to modify the layout of the printed content defined by the exemplary layout file shown above may replace or modify the layout attributes in the exemplary content file shown above with different layout attributes.

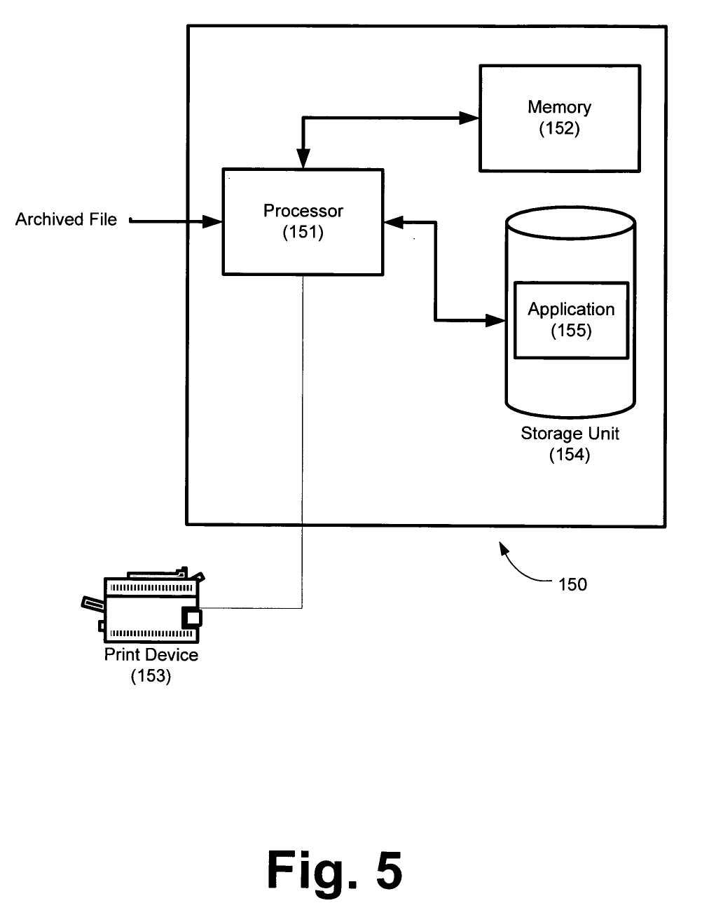

FIG. 5 illustrates an exemplary system (150) for creating one or more print files and then forming printed content corresponding to an optical disc. The print files may include one or more content files and one or more layout files. Alternatively, the print files may include a single print file containing both content information and layout attributes. The system shown in FIG. 5 is exemplary and may be modified as best serves a particular application.

As shown in FIG. 5, the system (150) comprises a processor (151), a memory unit (152), and a storage unit (154). The storage unit (154) may be a hard drive, optical disc, or any other memory storage device for example. The storage unit (154) may have an application (155) resident thereon that may be executed by the processor (151) to create the print files. The application (155) is not necessarily permanently resident on the storage unit (154). In an alternative embodiment, the application (155) may be temporarily resident in the system's memory (152).

The processor (151) is configured to receive the print files from the application (155) and render the printed content based on the data included in the print files. The rendered printed content may then be printed by a print device (153). The print device may be, as explained above, a printer, optical disc drive, or some other print device.

The preceding description has been presented only to illustrate and describe embodiments of invention. It is not intended to be exhaustive or to limit the invention to any precise form disclosed. Many modifications and variations are possible in light of the above teaching. It is intended that the scope of the invention be defined by the following claims.

1. A method of forming printed content, said method comprising:
creating one or more print files including data that defines said printed content such that said print files adhere to a pre-defined format; and
using said print files to render said printed content to a print device;
wherein said pre-defined format is configured to allow said print files to be modified after said print files have been initially created.

2. The method of claim 1, further comprising:
parsing said data in said print files for valid data;
wherein said printed content is printed only if said data in said print files is valid data.

3. The method of claim 2, wherein said step of parsing said data in said print files for valid data comprises validating said data against a schema.

4. The method of claim 1, wherein said print files comprise:
a content file defining a number of modifiable text elements and a number of modifiable image elements associated with said printed content; and
a layout file defining modifiable layout attributes of said text elements and said image elements.

5. The method of claim 4, further comprising naming said content file and said layout file in a manner that allows a processor to distinguish between said content file and said layout file.

6. The method of claim 4, further comprising dynamically modifying said layout attributes to adapt to a particular print geometry.

7. The method of claim 1, wherein said one or more print files comprise a single print file, said print file defining:
a number of modifiable text elements;
a number of modifiable image elements; and
layout attributes of said text elements and said image elements.

8. The method of claim 1, wherein said print files are text-based.

9. The method of claim 8, wherein said print files are created in Extensible Markup Language (XML).

10. The method of claim 1, wherein said step of creating said print files comprises:
combining descriptor terms with file-specific information;
wherein said descriptor terms distinguish data in said print files between a number of text elements, a number of image elements, and layout attributes corresponding to said text and image elements.

11. The method of claim 1, wherein said printed content is associated with an optical disc.

12. A method of printing an optical disc label, said method comprising:
creating one or more print files including data that defines said optical disc label such that said print files adhere to a pre-defined format; and
using said print files to render said optical disc label to a print device;
wherein said pre-defined format is configured to allow said print files to be modified after said print files have been initially created.

13. The method of claim 12, further comprising:
parsing said data in said print files for valid data;
wherein said printed content is printed only if said data in said print files is valid data.

14. The method of claim 13, wherein said step of parsing said data in said print files for valid data comprises validating said data against a schema.

15. The method of claim 12, wherein said print files comprise:
a content file defining a number of modifiable text elements and a number of modifiable image elements associated with said optical disc label; and
a layout file defining modifiable layout attributes of said text elements and said image elements.

16. The method of claim 15, further comprising naming said content file and said layout file in a manner that allows a processor to distinguish between said content file and said layout file.

17. The method of claim 15, further comprising dynamically modifying said layout attributes to adapt to a particular optical disc.

18. The method of claim 12, wherein said one or more print files comprise a single print file, said print file defining:
a number of modifiable text elements associated with said optical disc label;
a number of modifiable image elements associated with said optical disc label; and
layout attributes of said text elements and said image elements.

19. The method of claim 12, wherein said one or more print files are text-based.

20. The method of claim 19, wherein said print files are created in Extensible Markup Language (XML).

21. The method of claim 12, wherein said step of creating said print files comprises:
combining a descriptor term with a quantity of file-specific information;
wherein said descriptor terms distinguish data in said print files between a number of text elements, a number of image elements, and layout attributes corresponding to said text and image elements.

22. A system for forming printed content, said system comprising:
an application resident in a storage unit, said application configured to create one or more print files including data that defines said printed content such that said print files adhere to a pre-defined format;
a print device configured to print said printed content; and
a processor configured to use said print files to render said printed content to said print device;
wherein said pre-defined format is configured to allow said print files to be modified after said print files have been initially created.

23. The system of claim 22, wherein said print device prints said printed content only if said data in said print files is valid data.

24. The system of claim 23, wherein said application is configured to validate said data against a schema.

25. The system of claim 24, wherein said print files comprise:
a content file defining a number of modifiable text elements and a number of modifiable image elements in said printed content; and
a layout file defining modifiable layout attributes of said text and image elements.

26. The system of claim 25, wherein said content file and said layout file are named in a manner that allows said processor to distinguish between said content file and said layout file.

27. The system of claim 25, wherein said processor automatically modifies said layout attributes to adapt to a particular print geometry.

28. The system of claim 22, wherein said one or more print files comprise a single print file, said print file defining:
a number of modifiable text elements;
a number of modifiable image elements; and
layout attributes of said text and image elements.

29. The system of claim 22, wherein said print files are text-based.

30. The system of claim 29, wherein said print files are created in Extensible Markup Language (XML).

31. The system of claim 22, wherein said application is further configured to:
combine descriptor terms with file-specific information;
wherein said descriptor terms distinguish data in said print files between a number of text elements, a number of image elements, and layout attributes corresponding to said text and image elements.

32. The system of claim 22, wherein said printed content is associated with an optical disc.

33. The system of claim 22, wherein said printed content comprises a label.

34. A system for printing an optical disc label, said system comprising:
an application resident in a storage unit, said application configured to create one or more print files comprising data that defines said optical disc label such that said print files adhere to a pre-defined format;
a print device configured to print said optical disc label; and
a processor configured to use said print files to render said optical disc label to said print device;
wherein said pre-defined format is configured to allow said print files to be modified after said print files have been initially created.

35. The system of claim 34, wherein said print device prints said optical disc label only if said data in said print files comprises valid data.

36. The system of claim 35, wherein said application is configured to validate said data against a schema.

37. The system of claim 36, wherein said print files comprise:
a content file defining a number of modifiable text elements and a number of modifiable image elements included in said optical disc label; and
a layout file defining modifiable layout attributes of said text and image elements.

38. The system of claim 37, wherein said content file and said layout file are named in a manner that allows said processor to distinguish between said content file and said layout file.

39. The system of claim 37, wherein said processor automatically modifies said layout attributes to adapt to a particular optical disc.

40. The system of claim 34, wherein said one or more print files comprise a single print file, said print file defining:
a number of modifiable text elements associated with said optical disc label;
a number of modifiable image elements associated with said optical disc label; and
layout attributes of said text and image elements.

41. The system of claim 34, wherein said print files are text-based.

42. The system of claim 41, wherein said print files are created in Extensible Markup Language (XML).

43. The system of claim 34, wherein said application is further configured to:
combine descriptor terms with file-specific information;
wherein said descriptor terms distinguish data in said print files between a number of text elements, a number of image elements, and layout attributes corresponding to said text and image elements.

44. A system for forming printed content, said system comprising:
means for creating one or more print files including data that defines said printed content such that said print files adhere to a pre-defined format; and
means for using said print files to render said printed content to a print device;
wherein said pre-defined format is configured to allow said print files to be modified after said print files have been initially created.

45. The system of claim 44, further comprising:
means for parsing said data in said print files for valid data;
wherein said printed content is printed only if said data in said print files is valid data.

46. The system of claim 44, wherein said means for creating said print files comprises:
means for combining descriptor terms with file-specific information;
wherein said descriptor terms distinguish data in said print files between a number of text elements, a number of image elements, and layout attributes corresponding to said text and image elements.

47. A processor readable medium having instructions thereon for:
creating one or more print files including data that defines said printed content such that said print files adhere to a pre-defined format; and
using said print files to render said printed content to a print device;
wherein said pre-defined format is configured to allow said print files to be modified after said print files have been initially created.

48. The processor readable medium of claim 47, further comprising instructions for:
parsing said data in said print files for valid data;
wherein said printed content is printed only if said data in said print files is valid data.
